(19) United States
(12) Patent Application Publication
(10) Pub. No.: US 2009/0026787 A1
(43) Pub. Date: Jan. 29, 2009

(54) INSULATION STRUCTURE FOR THE INTERNAL INSULATION OF A VEHICLE

(75) Inventors: Rainer Muller, Rosengarten (DE); Peter Turanski, Sustedt (DE); Wilko Oestereich, Syke (DE); Reinelt Thorsten, Bremen (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland Gmbh, Hamburg (DE)

(21) Appl. No.: 10/596,993

(22) PCT Filed: Jan. 5, 2005
(86) PCT No.: PCT/EP2005/000039

§ 371 Date: Sep. 6, 2006

Related U.S. Application Data
(60) Provisional application No. 60/600,108, filed on Aug. 9, 2004.

(30) Foreign Application Priority Data
Jan. 5, 2004 (DE) 10 2004 001 081.1

(51) Int. Cl. B60R 13/01

(52) U.S. Cl. 296/39.1

(57) ABSTRACT

The present invention relates to an insulation structure for the internal insulation of a vehicle. The insulation structure will contribute to ensuring the fire protection for interior regions of the vehicle from a (conceivable) fire incursion from outside the vehicle environment, so that evacuation of the passengers from the vehicle is made significantly easier. Intended modifications to a typical insulation package will implement an elevation of the fire protection safety for separated interior regions lying proximal to a structure external skin.

The insulation structure for the internal insulation of a vehicle comprises an insulation package, which is implemented using an insulation, and a film, which is positioned inside an intermediate space that includes internal paneling and an external skin of the vehicle. The insulation package is implemented homogeneously using a first insulation, whose insulation material is burn-through safe. Otherwise, the insulation package is constructed using distinct insulation regions, which are implemented using the first insulation and a second insulation, whose insulation material is burn-through unsafe. These insulation regions are positioned along a finite series and laid next to one another up to a terminating insulation region, whose insulation material is exchanged in alternating sequence. Otherwise, the insulation package is implemented homogeneously using a second insulation, whose insulation material is burn-through unsafe (fire endangered, flammable), multiple burn-through safe barrier layers being integrated in the second insulation.

### CROSS REFERENCE TO RELATED APPLICATIONS

The present application claims priority of DE 10 2004 001 081 filed Jan. 5, 2004 and U.S. 60/600,108 filed Aug. 9, 2004, which are both hereby incorporated by reference.

### FIELD OF THE INVENTION

The present invention relates to an insulation. In particular, the present invention relates to an insulation structure for the internal insulation of a vehicle. The insulation structure is useful for protecting the internal region of a vehicle from a fire incursion from outside the vehicle surroundings, so that evacuation of the passengers from the vehicle may be made easier.

### BACKGROUND OF THE INVENTION

Conventional insulation systems essentially comprise a core material, which is embedded in an insulation package, and an envelope. The core and insulation materials used generally include products of the fiber industry, of which fiber glass materials (glass wool) are used in particular. This material fulfils the requirements in regard to thermal and acoustic insulation. In order to implement mounting (attachment) of the relatively amorphous semi finished products to the vehicle structure, the insulation package (comprising these semi finished products) is enclosed by an envelope film. Reinforcements are attached to the ends of the envelope film in order to thus attach a (therefore complete) insulation package to the structure surfaces of a vehicle with the aid of fasteners.

Insulation packages of this type are attached to the frames of the aircraft fuselage structure by means of fasteners which are typically made of plastic(s), for example, polyamide. The typical insulation systems, which comprise glass wool and simple plastic films, may have a bum-through time of approximately sixty seconds.

In case of fire in an aircraft parked on the ground, i.e. the “post-crash fire scenario”, burning kerosene may cause the aluminum cells of the aircraft structure and even the fuselage insulation (internal insulation) of the aircraft to burn through. There is always a desire to increase the burn trough time, or to increase the time the structure may withstand the fire.

As mentioned above, typical fasteners of the insulation are made of non-metallic materials (plastics), which are usually not able to resist the fire in case of catastrophe for an extended period of time. Due to this, a collapse of the burning insulation (insulation packages) may occur, because of which uncontrollable obstructions or other fire danger points would (suddenly) be present.

WO 00/75012 A 1 discloses a fuselage insulation for an aircraft fuselage which is specified as “fire-blocking”. This publication discloses an insulation package which is positioned as the primary insulation within a spatial region which lies between the fuselage internal paneling and the fuselage external skin. In this case, this insulation package is protected in areas by a film made of fire-blocking material. This fire-blocking film region is directly facing toward the external skin of the aircraft fuselage (as a type of fire protection shield). Neglecting the fact that only insufficient protection of the insulation package and also the fuselage internal region from occurring fire may be provided using this suggestion, since during a fire catastrophe the flames of fire may pass from outside the aircraft through a damaged external skin and may feed on the internal insulation, i.e., would pass through the (only) fire-blocking, but not fire-resistant film upon permanent fire strain, the intended regional positioning of an only fire-blocking film may not be able to ensure fire protection safety in relation to the fuselage inside region for an extended period of time.

### SUMMARY OF THE INVENTION

According to an exemplary embodiment of the present invention, an insulation structure for the internal insulation of a vehicle is provided, which comprises an insulation package, implemented using an insulation, and a film, which is positioned inside an intermediate space that includes internal paneling and an external skin of the vehicle. According to an aspect of the present invention, the insulation package is implemented homogeneously using a first (burn-through safe) insulation, which insulation material is burn-through safe.

It is believed that according to this exemplary embodiment of the present invention, an insulation structure of a vehicle may be provided, which may be used for internal insulation, in such a way that a fire overlap of the flames of a source of fire acting from outside the vehicle surroundings into the vehicle interior is excluded or prevented for an extended period of time. This may allow for an increase of the fire protection safety for separate interior regions lying near a structure external skin being implemented through intentional modifications of a typical insulation assembly.

### BRIEF DESCRIPTION OF THE DRAWING

The present invention is described in greater detail in exemplary embodiments on the basis of the attached drawing.

FIG. 1 shows an insulation structure for the internal insulation of a commercial aircraft having a burn-through safe film envelope of the insulation assembly;

FIG. 2 shows a film-enveloped insulation structure for the internal insulation of a commercial aircraft having a burn-through safe insulation;

FIG. 3 shows a film-enveloped insulation structure for the internal insulation of a commercial aircraft having an insulation assembly constructed from two distinct insulation regions;

FIG. 4 shows a film-enveloped insulation structure for the internal insulation of a commercial aircraft having an insulation assembly comprising three insulation regions and constructed from two distinct insulation regions;

FIG. 5 shows a film-enveloped insulation structure for the internal insulation of a commercial aircraft having a burn-through unsafe insulation comprising two barrier layers.

### DETAILED DESCRIPTION OF EXEMPLARY EMBODIMENTS

It is assumed that the insulation structure specified in the following, which is used for the internal insulation of a (generally identified) vehicle and especially an aircraft, comprises an insulation assembly 3 and a (generally specified) film, the insulation assembly 3 considering a (generally specified) insulation which is shaped into a package. The insulation assembly is typically enveloped by the film in order to provide a type of internal support to the insulation (for whatever reasons) and ensure maintenance of the desired assembly shape of the insulation assembly 3. This insulation structure is positioned inside an intermediate space, which encloses a fuselage internal paneling and a fuselage external skin of an aircraft, for example.

In order to make the above-mentioned illustration more understandable for the observer, it is additionally noted that in the strength bracing of the aircraft fuselage, the latter has, in addition to the stringers with which all external skin panels of an aircraft fuselage structure are stiffened, multiple frames, which are positioned perpendicularly to the aircraft longitudinal axis (not shown) at (approximately) a defined interval and attached to the stringers. These frames may be integrated at the unattached end of a frame girder, which is extended parallel to the aircraft longitudinal axis, the (unattached free) end of the frame girder being angled perpendicularly to the aircraft longitudinal axis, for example. In this case, this insulation structure, i.e., the film-enveloped insulation assembly 3, is laid at or near the fuselage external skin and/or an external skin section of the fine length (along a fuselage longitudinal axis) on stringers and attached to frames positioned in intervals (of the defined length).

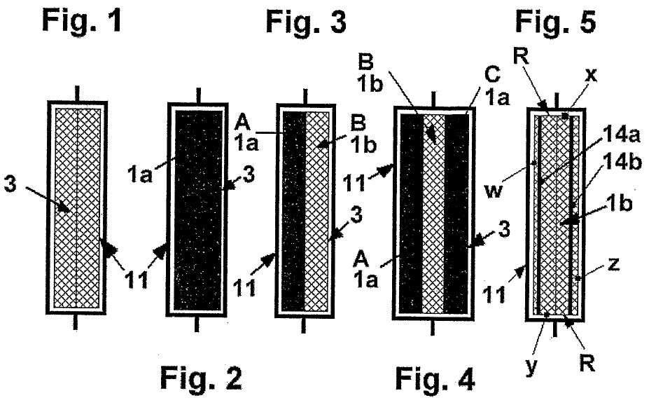

The illustration in FIG. 1 also shows that solely the installation of a insulation package 3, which is essentially completely enveloped by a burn-through safe film 11, may be sufficient to achieve effective fire protection against the flame of a fire or to increase the fire withstanding time of the respective structure.

In this case, the insulation structure considers an insulation package 3 that considers (only) one second insulation 1b, which is constructed using a burn-through unsafe insulation material, this insulation structure already causing effective fire protection against the flames of the fire which would act on the insulation structure—especially on the external region of the film surface. This second insulation 1b of the insulation package 3 is used as a fire barrier.

In order to achieve a further elevation (increase) of the fire protection safety for separated interior regions lying near a structure external skin, further modifications of an insulation package 3 will be suggested, which may be inferred from the illustrations in FIGS. 2 through 5.

The embodiment in FIG. 2 considers an insulation package 3 which is implemented homogeneously (completely, entirely) using a first (burn-through safe) insulation 1a, whose insulation material is burn-through safe. This insulation la is specified with a bum-through safe material which will be specified in more detail at the end of the explanation of all embodiments of an insulation package 3.

The film protection of the insulation package, which considers a burn-through safe material, is a prophylactic implementation (in comparison to the insulation structure in FIG. 1) of an increase of the burn safety from fire acting (unfavorably) from outside the aircraft fuselage in the case of a fire catastrophe, but is more cost-intensive.

The embodiments in FIGS. 3 and 4, which certainly appear very similar, assume that the insulation package 3 is constructed having distinct insulation regions A, B, C, a variation of the thickness of the individual first insulation regions A, C certainly influencing (for the above-mentioned purpose) an improvement of the fire safety of the insulation package 3. According to the pattern in FIG. 4, these insulation regions A, B, C are positioned along a finite series, and are laid next to one another in alternating sequence, for example, in the sequence: “first insulation region A—middle insulation region B—final insulation region C”. The insulation regions A, C are implemented using a first insulation 1a (except for the insulation region terminating the series), whose insulation material is burn-through safe. A second insulation region B, which is positioned along the series next to the insulation regions A, C with burn-through safe insulation material neighboring (interposed), is equipped with a second insulation 1b, whose insulation material is burn-through unsafe (fire endangered, flammable). The construction of the insulation package 3 is designed so that a first insulation region A and an insulation region terminating the series are implemented using the insulation material of the first insulation 1a, i.e., using a burn-through safe insulation, which is used as a fire barrier.

FIG. 3 shows a special form of the insulation structure in FIG. 4, which—in comparison to the illustration in FIG. 4—dispenses with the proximal positioning of a third insulation region C (terminating the series). In this arrangement, the first insulation region A having the burn-through safe insulation material faces toward the external skin, if one wishes to achieve an effective fire protection against the flames of a fire toward the outside of the aircraft.

FIG. 4 shows an exemplary sequence of the above-mentioned structure, i.e., a second insulation region B, which is implemented using the burn-through unsafe insulation material of the second insulation lb, is laid next to each of a first and a third insulation region A, C, which is equipped with the burn-through safe insulation material of the first insulation 1b.

As noted, it is generally intended that in each case a further burn-through unsafe insulation region, which corresponds to the pattern of the second insulation region B, is always continued following the third insulation region C and each further insulation region corresponding to the pattern of the first insulation 1b, until reaching the final (burn-through safe) insulation region at the end of the series.

The embodiment in FIG. 5 assumes that the insulation package 3 is implemented integrally with a second insulation 1b [an identical insulation], whose insulation material is burn-through unsafe (fire endangered, flammable), but multiple burn-through safe barrier layers 14, 14a, which are used as fire barriers, are integrated.

In the specific case, it may be intended that only one burn-through safe barrier layer 14 or 14a is integrated in the second insulation 1b as a fire barrier. In this case, the single barrier layer 14, 14a would run without interruption through the second insulation 1b, leading up to the peripheral edge R (up to the circumference) of the second insulation 1b. In this case (according to the pattern of FIG. 5) the vertical course of the single barrier layer 14a, 14b would be delimited by two boundary faces x, y of the second insulation 1b, which are positioned horizontally and are vertically diametrically opposing. The single barrier layer 14a, 14b would thus run near the boundary faces w, z or otherwise the relevant end of the single barrier layer 14a, 14b would press against the two boundary faces w, z.

The closed (uninterrupted) course of the barrier layers 14a, 14b through the second insulation 1b is implemented in a straight line according to the pattern of FIG. 5, a zigzagged or curved course (for whatever reasons) otherwise also being conceivable. If a curved course of the single barrier layer 14a, 14b is intended, this course may be designed as sinusoidal or cosinusoidal.

It is also to be noted that further embodiments of the insulation structure in FIG. 5 may consider the further arrangement of barrier layers 14a or 14b positioned at an interval and implemented in a straight line. An insulation structure according to FIG. 5, which only considers one single barrier layer 14a, 14b, would also be entirely conceivable. In this case, the thickness of the barrier layer 14, 14a and its differentiated positioning within the structure presented (according to FIG. 5) would be a function of the specified conditions (weight, selection of the layer material (specified in the following), fire protection safety required by the airliner, etc.).

All embodiments of a layered structure in FIGS. 2 through 5 may have the following shared features.

The first and the second insulations 1a, 1b or the insulation regions A, B, C (including further positioned insulation regions) or the barrier layers 14a, 14b (including further positioned barrier layers) are situated in a position approximately parallel to the external skin of a (generally identified) vehicle or (especially) parallel to the fuselage external skin of an aircraft. An approximately parallel position indicates the presence of similar positions of these elements to the external skin.

Accordingly, it may be that the vertical position of the insulations 1a, 1b or the insulation regions A, B, C (including further positioned insulation regions) or the barrier layers 14a, 14b (including further positioned barrier layers) is tailored to the contour (to the outline) or to the curvature of the external skin (fuselage external skin of an aircraft).

The cited film 11, the first insulation 1a, and the barrier layers 14a, 14b (including further positioned barrier layers) are implemented using a material of high fire resistance, which is implemented as sufficiently resistant and/or insensitive to occurring fire, because of which propagation of the fire, which will flame against a surface region of the barrier layer in this situation, is prevented.

In this case, the first insulation la and/or the barrier layers 14a, 14b (including further positioned barrier layers) are implemented using a fireproof fibrous material.

The fibrous material is implemented using ceramic, carbon, or silicate fibers.

It is also to be noted that the insulation package 3 is essentially completely enveloped by the burn-through safe film 11, through which additional elevation of the fire protection safety is achieved. The insulations 1a, 1b or the insulation regions A, B, C (including further positioned insulation regions) shown in FIGS. 2 through 4 are completely enveloped by the film 11. The second insulation lb in FIGS. 1 and 5, including the barrier layers 14a, 14b in FIG. 5, is completely enveloped by the film 11. In the special case in FIG. 1, this fire protection safety of the insulation structure is first implemented by the installation of the film 11.

Finally, the use of the first insulation la and the barrier layers 14a, 14b (including further positioned barrier layers) is noted, which, as a fire barrier or fire barricade, would offer a type of protective shield against the fire acting from outside the vehicle and penetrating in the direction of the vehicle interior and through the (damaged or burned through) external skin in case of a fire catastrophe.

### LIST OF REFERENCE NUMBERS

1
1a first insulation, burn-through safe
1b second insulation, bum-through unsafe
2
3 insulation package
4
5
6
7
8
9
10
11 film
14a barrier layer, bum-through safe
14b barrier layer, bum-through unsafe
w boundary face (of the second insulation 1b), positioned vertically
x boundary face (of the second insulation 1b), positioned horizontally
y boundary face (of the second insulation 1b), positioned horizontally
z boundary face (of the second insulation 1b), positioned vertically
A first insulation region, bum-through safe
B second insulation region, burn-through unsafe
C third insulation region, bum-through safe
R peripheral edge (of the second insulation 1b)

1. An insulation structure for the internal insulation of a vehicle, comprising an insulation package, implemented using an insulation, and a film, which is positioned inside an intermediate space between internal paneling and an external skin of the vehicle, wherein the insulation package is constructed using distinct insulation regions, which are implemented using a first insulation whose insulation material is burn-through safe, and a second insulation whose insulation material is burn-through unsafe, these insulation regions being positioned along a finite series and laid next to one another up to a final insulation region, whose insulation material is exchanged in alternating sequence.

2. An insulation structure for the internal insulation of a vehicle, comprising an insulation package, implemented using an insulation, and a film, which is positioned inside an intermediate space between internal paneling and an external skin of the vehicle, wherein the insulation package is implemented homogeneously using a second insulation, whose insulation material is burn-through unsafe, in which multiple burn-through safe barrier layers are integrated.

3. The insulation structure of claim 1, wherein a first insulation region and an insulation region terminating the series are implemented using the insulation material of the first insulation.

4. The insulation structure of claim 1, wherein a second insulation region, which is implemented using the burn-through unsafe insulation material of the second insulation, is laid next to each of a first and a third insulation region, which are equipped with the burn-through safe insulation material of the first insulation, and following the third and each further insulation region, which are equipped with the burn-through safe insulation material of the first insulation, a further insulation region is positioned, which is equipped with the burn-through unsafe insulation material of the second insulation.

5. (canceled)

6. (canceled)

7. (canceled)

8. (canceled)

9. (canceled)

10. (canceled)

11. (canceled)

12. The insulation structure of claim 1, wherein the film, the first insulation, and the barrier layers are implemented using a material of high fire resistance, which is implemented as sufficiently resistant or insensitive to occurring fire or both, because of which propagation of the fire, which would flame against a surface region of the barrier layer in this situation, is prevented.

13. (canceled)

14. (canceled)

15. (canceled)

16. (canceled)

17. (canceled)

18. (canceled)

19. An insulation structure for the internal insulation of a vehicle subject to accidental exposure of the vehicle to a fire external to the vehicle, the insulation structure comprising an insulation package capable of insertion between internal paneling and an external skin of the vehicle, and the insulation package comprises:
at least one barrier layer;
at least one insulation region; and
a film providing an external surface of the insulation package, wherein the at least one insulation region is not capable of preventing burn-through of the fire, and the at least one barrier layer is capable of preventing burn-through of the fire, and the at least one barrier layer is positioned such that the insulation package is made burn through safe.

20. The insulation structure of claim 19, wherein the at least one barrier layer is comprised of at least one burn-through safe insulation region.

21. The insulation structure of claim 19, wherein the at least one barrier layer is a plurality of barrier layers, and the plurality of barrier layers are integrated in the at least one insulation region.

22. The insulation structure of claim 20, wherein the at least one barrier layer is comprised of at least two burn through safe insulation regions.

23. The insulation structure of claim 22, wherein an insulation region is disposed between the at least two burn through safe insulation regions.

24. The insulation structure of claim 21, wherein the plurality of barrier layers leads without interruption through the at least one insulation region and up to a peripheral edge of at least one insulation region.

25. The insulation structure of claim 21, wherein the vertical course of the plurality of barrier layers is delimited by two inner vertically diametrically opposed and horizontally positioned boundary faces of at least two insulation regions.

26. The insulation structure of claim 21, wherein the plurality of barrier layers leads close to or presses against two outer boundary faces of the at least one insulation region, the two outer boundary faces being horizontally diametrically opposing and vertically positioned.

27. The insulation structure of claim 21, wherein a closed course of the plurality of the barrier layers is implemented by the at least one insulation region which is implemented as straight or zigzagged or curved.

28. The insulation structure of claim 27, where the closed course of at least one of the plurality of barrier layers is designed as sinusoidal or cosinusoidal.

29. The insulation structure of claim 19, wherein the insulation package is shaped to a curvature of the external skin.

30. The insulation structure of claim 19, wherein the film and the at least one barrier layer is of a fire resistant material.

31. The insulation structure of claim 30, wherein the at least one barrier layer is of a fireproof fibrous material.

32. The insulation structure of claim 31, wherein the fireproof fibrous material is of a ceramic, a carbon, a silicate or combinations thereof.

33. The insulation structure of claim 19, wherein the insulation package is completely enveloped by the film.
